(19) United States
(12) Patent Application Publication
(10) Pub. No.: US 2014/0092615 A1
(43) Pub. Date: Apr. 3, 2014

(54) CONCENTRIC LIGHTING MODULE WITH CONICAL MIRROR

(71) Applicants: Miroslav Kropac, Ostrava (CZ); Libor Juttner, Novy Jicin (CZ); Tomas Nejezchleba, Novy Jicin (CZ); Ivana Chmielova, Havisov (CZ)

(72) Inventors: Miroslav Kropac, Ostrava (CZ); Libor Juttner, Novy Jicin (CZ); Tomas Nejezchleba, Novy Jicin (CZ); Ivana Chmielova, Havisov (CZ)

(73) Assignee: VARROC LIGHTING SYSTEMS S.R.O.

(21) Appl. No.: 14/015,276

(22) Filed: Aug. 30, 2013

(30) Foreign Application Priority Data
Oct. 3, 2012 (CZ) PV 2012-676

(51) Int. Cl. F21S 8/10

(52) U.S. Cl. CPC F21S 48/236
USPC 362/511

(57) ABSTRACT

A concentric lighting module with conical mirror for creating of a three-dimensional optical effect, especially in the outer brake and tail lights of a motor vehicle, has in the peripheral region of the conical mirror (3) a cylindrical output part (2c) of a light guide (2) provided by at least one offset (2d) on its outer side, which terminates in an active surface (2e) and which couples in the region beyond the conical mirror (3) to the collimator part (2b) of the light guide (2), formed by a parabolic collimator and a lens and applied by its input part (2a) against the light source (1) of the module, and at the transition between the collimator part (2b) and the output part (2c) of the light guide (2) the module is provided with a total internal light reflection surface (4), whose bottom part also forms an optical prism (4a).

### FIELD OF TECHNOLOGY

The invention concerns a concentric lighting module with conical mirror, to create a three-dimensional optical effect, especially in the outside brake and tail lights of a motor vehicle.

### PRIOR ART

At present there is known from the specification of US 2011/0149585 A1 a lighting module designed for the outside rear lighting of a motor vehicle, which creates a 3D optical lighting effect.

This module consists of a curved reflector with a system of openings by which light from light sources is directed both onto a transparent peripheral part of the module arranged in front of the reflector, to create external light traces, and onto the partially transparent (semitransparent metallization) center of the module, which fills the space bounded by the transparent part.

One portion of the light rays emanating from each light source and directed onto the outer edge of the partially transparent middle of the module passes through this partially transparent center and creates a light trace on its outer side. Another portion of the light rays emanating from each light source of the module and directed onto the outer edge of the partially transparent center of the module is reflected by the partially transparent center back onto the reflecting surface of the reflector, from which it is again reflected in the direction of the partially transparent center of the module. One portion of these light rays then passes through the partially transparent center of the module and creates a further light trace on its outer side. Another portion of these rays is reflected by the transparent center back onto the reflecting surface of the reflector. The further path of the light rays on their way to the center of the module is but a repeating of the previous cycle. In this way, one can create several light traces on the outside of the partially transparent center of the module, for example, in the shape of concentric circles, squares, triangles, and so on, with a 3D optical lighting (so-called tunnel) effect.

The drawback of this lighting module is especially its fabrication and material intensity.

### ESSENCE OF THE INVENTION

The aforementioned drawbacks are eliminated to a significant degree by the concentric lighting module with a conical mirror for creating of a three-dimensional optical effect, especially in the outer brake and tail lights of a motor vehicle, according to this invention, whose essence lies in that, in the peripheral region of the conical mirror, a cylindrical output part of a light guide is provided by at least one offset on its outer side, terminating in an active surface and coupling in the region beyond the conical mirror to the collimator part of the light guide, formed by a parabolic collimator and a lens and applied by its input part against the light source of the module, and at the transition between the collimator part and the output part of the light guide the module is modified by a total internal light reflection surface, whose bottom part forms an optical channel.

Another essence of this invention is that the conical mirror has its angle of rotation in the range of 1° to 360° and in the cross section drawn by the concentric axis of the module, in the region opposite the offsets of the output part of the light guide, it has the shape of a straight line and/or a concave curve and/or a convex curve, such that it reflects the decoupled light by means of the offsets in the direction of the axis of rotation of the conical mirror.

Another essence of this design of a concentric lighting module with conical mirror is the fact that the light source is an incandescent bulb or a LED diode, and the light guide is formed as a separate part of the module.

Finally, an essence of this invention is the fact that the active light guiding surface of the light guide is supplemented by light scattering elements or speckling or it is formed of scattering material in any given manner, and that light scattering elements in the form of pads and/or strips form the reflecting surface of the light guide.

The advantage of this design is low fabrication and material costs and a better resulting 3D optical light effect.

### REVIEW OF FIGURES IN THE DRAWINGS

Possible sample embodiments of the concentric lighting module with conical mirror according to this invention are illustrated in the enclosed drawings, where FIG. 1 presents a schematic longitudinal section of the light module, while

FIG. 2 is an axonometric view of half of the light module in a specific embodiment showing the path of the light rays.

### SAMPLE EMBODIMENTS OF THE INVENTION

As can be seen in FIG. 1, the lighting module with conical mirror for creating a three-dimensional optical effect, especially in the outer brake and tail lights of a motor vehicle, has a cylindrical output part 2c of a light guide 2 arranged in the peripheral region of the conical mirror 3 and provided with two offsets 2d on its outer side, terminating in an active surface 2e to form the outer peripheral light traces. The output part 2c of the light guide 2 is then coupled in the region beyond the conical mirror 3 to the collimator part 2b of the light guide 2, which is applied by its planar input part 2a against the light source I of the module, situated in the concentric axis of the module. The light source 1 in the given case is an incandescent bulb, but it can also be replaced by an LED diode.

The transition between the output part 2c and the collimator part 2b of the light guide 2 is provided with a total internal light reflecting surface 4, whose bottom part forms an optical prism 4a of the light guide 2. A lens which is an integral component of the collimator part 2b of the light guide 2 focuses the light from the light source 1 on the input surface of the optical prism 4a.

The conical mirror 3 in the present case has the shape of a straight line in the cross section drawn through the concentric axis of the module, in the region opposite the offsets 2d of the output part 2c of the light guide 2. However, the shape of the conical mirror 3 can be modified as needed to the shape of a straight line and/or a concave curve and/or a convex curve, so that it reflects the light decoupled by means of the offsets 2d in the direction of the axis of rotation of the conical mirror 3.

Just like the shape of the conical mirror 3 it is also possible to choose the size of its angle of rotation. The lighting module need not always be only one of rotation, but can also have a shape in cross section of a sector of a semicircle, for example, with a center angle of 90° or 120° or 180°. Ultimately, the lighting module need not even be rotational, it can be elliptical, for example, and it is even possible to arbitrarily join together several profile curves.

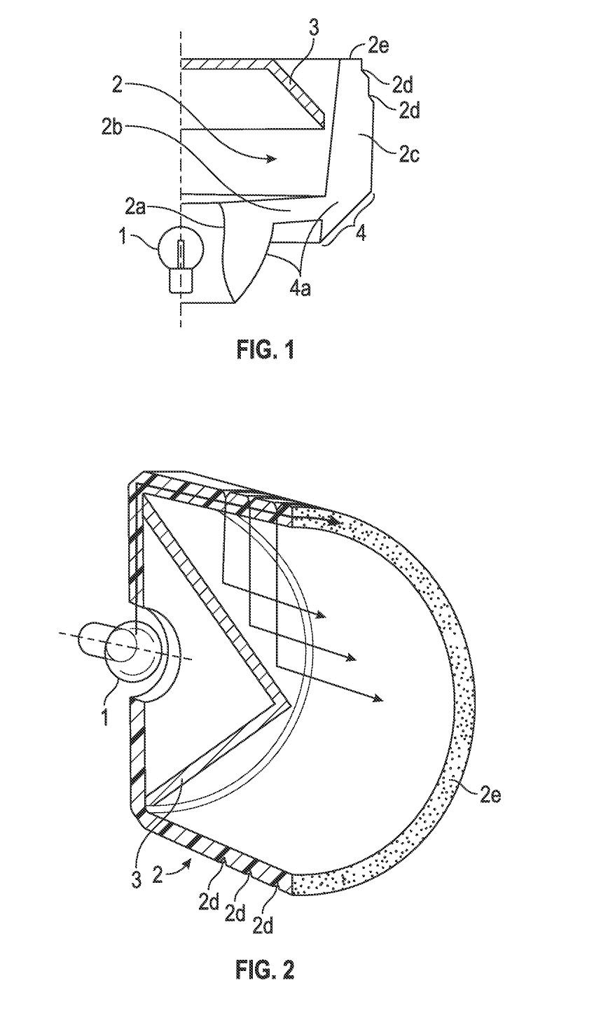

The function of the individual parts of the lighting module may be understood from FIG. 2.

In advantageous embodiments (not shown), the output part 2c of the light guide 2 can be formed, for example, as an independent part of the module separate from the collimator part 2b and its active surface 2e can be supplemented with light scattering elements or speckling or created from scattering material in any given manner. Light scattering elements in the form of pads and/or strips can also be advantageously provided for the total-reflection surface 4 of the output part 2e of the light guide 2.

### LIST OF REFERENCE SYMBOLS USED

1—light source
2 —light guide
2a—input part
2b—collimator part
2c—output part
2d—offset
2e—active surface
3—conical mirror
4—total internal reflection surface
4a—optical prism

1. Concentric lighting module with conical mirror for creating of a three-dimensional optical effect, especially in the outer brake and tail lights of a motor vehicle, characterized in that, in the peripheral region of the conical mirror (3), a cylindrical output part (2c) of a light guide (2) is provided by at least one offset (2d) on its outer side, terminating in an active surface (2e) and coupling in the region beyond the conical mirror (3) to the collimator part (2b) of the light guide (2), formed by a parabolic collimator and a lens, applied by its input part (2a) against the light source (1) of the module, and at the transition between the collimator part (2b) and the output part (2c) of the light guide (2) the module is provided with a total internal light reflection surface (4), whose bottom part forms an optical prism.

2. Lighting module according to claim 1, characterized in that the conical mirror (3) has its angle of rotation in the range of 1° to 360°.

3. Lighting module according to claim 1, characterized in that the conical mirror (3) has, in the cross section drawn by the concentric axis of the module, in the region opposite the offsets (2d) of the output part (2c) of the light guide (2), the shape of a straight line and/or a concave curve and/or a convex curve, such that it reflects the decoupled light by means of the offsets (2d) in the direction of the axis of rotation of the conical mirror (3).

4. Lighting module according to claim 1, characterized in that the light source (1) is an incandescent bulb or a LED diode.

5. Lighting module according to claim 1, characterized in that the light guide (2) is formed as an independent part of the module.

6. Lighting module according to claim 5, characterized in that the active surface (2e) of the light guide (2) is supplemented by light scattering elements or speckling or it is formed from scattering material in any given manner

7. Lighting module according to claim 1, characterized in that light scattering elements in the form of pads and/or strips form the reflecting surface (4) of the light guide (2).
